(19) United States
(12) Patent Application Publication
(10) Pub. No.: US 2025/0141809 A1
(43) Pub. Date: May 1, 2025

(54) APPARATUS AND METHOD FOR PROVIDING FRAME PREEMPTION INFORMATION FOR TIME-SENSITIVE SERVICE IN WIRELESS COMMUNICATION SYSTEM

(71) Applicant: ELECTRONICS AND TELECOMMUNICATIONS RESEARCH INSTITUTE, Daejeon (KR)

(72) Inventors: Seung Han CHOI, Daejeon (KR); Changki KIM, Daejeon (KR)

(21) Appl. No.: 18/930,724

(22) Filed: Oct. 29, 2024

(30) Foreign Application Priority Data
Oct. 30, 2023 (KR) 10-2023-0147109
Oct. 22, 2024 (KR) 10-2024-0145058

(51) Int. Cl. H04L 47/28; H04L 1/08

(52) U.S. Cl. CPC H04L 47/28; H04L 1/08

(57) ABSTRACT

Proposed is an operation method of a session management function (SMF) for providing a time-sensitive service in a wireless communication system. The operation method includes receiving frame preemption information from a time-sensitive networking application function (TSN AF) or a time-sensitive communication and time synchronization function (TSCTSF) via a policy control function (PCF) through an SBI interface, retransmitting the frame preemption information from the PCF to a user plane function (UPF)/network-side TSN translator (NW-TT) through an N4 interface, transmitting the frame preemption information from the PCF to a user equipment (UE)/device-side TSN translator (DS-TT) through an Ni NAS interface, and receiving the frame preemption information set from the UPF/NW-TT through the N4 interface and from the UE/DS-TT through the Ni NAS interface and transmitting the frame preemption information to the TSN AF or the TSCTSF via the PCF through the SBI interface.

### CROSS REFERENCE TO RELATED APPLICATION

The present application claims priority to Korean Patent Application No. 10-2023-0147109, filed 30 Oct. 2023, and 10-2024-0145058, filed 22 Oct. 2024, the entire contents of which are incorporated herein for all purposes by this reference.

### BACKGROUND OF THE INVENTION

### Field of the Invention

The present disclosure relates generally to a wireless communication system. More particularly, the present disclosure relates to an apparatus and a method for providing frame preemption information for a time-sensitive service in a wireless communication system.

### Description of the Related Art

In order to meet the requirements for applications of various vertical industries of the 5GS, the 3rd Generation Partnership Project (3GPP) SA2 started 5G standardisation to support time-sensitive communication (TSC) from Rel-16. 3GPP TS 23.501 (Rel-16) defines the 5GS as one logical time-sensitive network (TSN) bridge, and only supports interworking with IEEE TSN.

Later, standardisation was carried out in which Rel-17 accepts time-sensitive application services in the environment of interworking with Non-TSN and Rel-18 defines the 5GS as one logical DetNet router and supports interworking with IETF Deterministic Network.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing an apparatus and a method for providing frame preemption information for a time-sensitive service in a wireless communication system.

In addition, the present disclosure is directed to providing an apparatus and a method for providing frame preemption information, in a wireless communication system, to a user plane function (UPF)/network-side TSN translator (NW-TT) or to a user equipment (UE)/device-side TSN translator (DS-TT) by a time-sensitive network application function (TSN AF) or by a TSC time synchronization function (TSCTSF).

According to various embodiments of the present disclosure, there is provided an operation method of a session management function (SMF) for providing a time-sensitive service in a wireless communication system, the operation method including: receiving frame preemption information from a time-sensitive networking application function (TSN AF) or a time-sensitive communication and time synchronization function (TSCTSF) via a policy control function (PCF) through an SBI interface; retransmitting the frame preemption information from the PCF to a user plane function (UPF)/network-side TSN translator (NW-TT) through an N4 interface; transmitting the frame preemption information from the PCF to a user equipment (UE)/device-side TSN translator (DS-TT) through an Ni NAS interface; and receiving the frame preemption information set from the UPF/NW-TT through the N4 interface and from the UE/DS-TT through the Ni NAS interface, and transmitting the frame preemption information to the TSN AF or the TSCTSF via the PCF through the SBI interface.

According to various embodiments of the present disclosure, there is provided a session management function (SMF) for providing a time-sensitive service in a wireless communication system, the session management function including: a transceiver; and a controller operably connected to the transceiver, wherein the controller is configured to receive frame preemption information from a time-sensitive networking application function (TSN AF) or a time-sensitive communication and time synchronization function (TSCTSF) via a policy control function (PCF) through an SBI interface, retransmit the frame preemption information from the PCF to a user plane function (UPF)/network-side TSN translator (NW-TT) through an N4 interface, transmit the frame preemption information from the PCF to a user equipment (UE)/device-side TSN translator (DS-TT) through an Ni NAS interface, and receive the frame preemption information set from the UPF/NW-TT through the N4 interface and from the UE/DS-TT through the Ni NAS interface and transmit the frame preemption information to the TSN AF or the TSCTSF via the PCF through the SBI interface.

The apparatus and the method according to various embodiments of the present disclosure can improve the reliability and accuracy of time-sensitive communication by providing and managing frame preemption information efficiently.

Effects that may be obtained from the present disclosure will not be limited to only the above described effects. In addition, other effects which are not described herein will become apparent to those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows an example of the architecture of a 5G system that supports a time-sensitive service according to various embodiments of the present disclosure;

FIG. 2 shows another example of the architecture of a 5G system that supports a time-sensitive service according to various embodiments of the present disclosure;

FIG. 3 shows still another example of the architecture of a 5G system that supports a time-sensitive service according to various embodiments of the present disclosure;

FIG. 4 shows an example for a TSN AF or TSCTSF to provide UMI or PMI according to various embodiments of the present disclosure; and

FIG. 5 shows an example for a TSN AF or TSCTSF to provide UMI or PMI according to an embodiment of the present disclosure.

FIG. 6 shows the configuration of a network entity in a wireless communication system according to various embodiments of the present disclosure.

FIG. 7 shows a configuration diagram of a user equipment in a wireless communication system according to various embodiments of the present disclosure.

### DETAILED DESCRIPTION OF THE INVENTION

The terms used in the present disclosure are merely used to describe a particular embodiment, and are not intended to limit the scope of another embodiment. An expression used in the singular encompasses the expression of the plural, unless it has a clearly different meaning in the context. All the terms including technical and scientific terms used herein have the same meaning as commonly understood by those skilled in the art to which the present disclosure belongs. Among the terms used in the present disclosure, the terms defined in a general dictionary may be interpreted to have the meanings the same as or similar to the contextual meanings in the relevant art, and are not to be interpreted to have ideal or excessively formal meanings unless explicitly defined in the present disclosure. In some cases, even the terms defined in the present disclosure should not be interpreted to exclude the embodiments of the present disclosure.

In various embodiments of the present disclosure to be described below, a hardware approach will be described as an example. However, the various embodiments of the present disclosure include a technology using both hardware and software, so the various embodiments of the present disclosure do not exclude a software-based approach.

In addition, in the detailed description and claims of the present disclosure, the expression “at least one of A, B, and C” mean “only A”, “only B”, “only C”, or “any combination of A, B, and C”. In addition, the expression “at least one of A, B, or C” or “at least one of A, B, and/or C” may mean “at least one of A, B, and C”.

Hereinafter, the present disclosure is to provide frame preemption information for a time-sensitive service in a wireless communication system. Specifically, the present disclosure can improve the reliability and accuracy of time-sensitive communication by providing and managing frame preemption information efficiently in a wireless communication system.

The terms referring to signals, the terms referring to channels, the terms referring to control information, the terms referring to network entities, the terms referring to elements of an apparatus, and the like used in the description below are only examples for the convenience of description. Accordingly, the present disclosure is not limited to the terms described below, and the terms may be replaced by other terms having the same technical meanings.

In addition, various embodiments of the present disclosure are described using terms used in some communication standards (e.g., the 3rd Generation Partnership Project (3GPP)), but the embodiments are only examples for the description. The various embodiments of the present disclosure may be easily modified and applied to other communication systems.

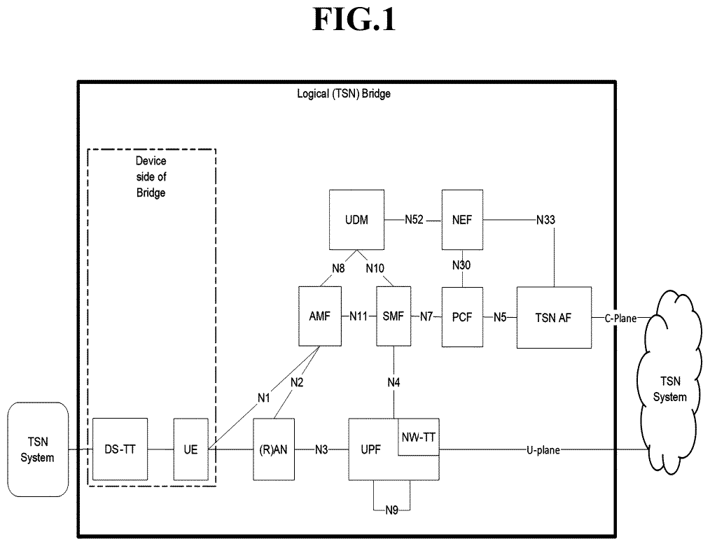

FIG. 1 shows an example of the architecture of a 5G system that supports a time-sensitive service according to various embodiments of the present disclosure. Specifically, FIG. 1 shows an example of the 5G system for supporting IEEE time-sensitive networking. FIG. 1 may be based on 3GPP TS 23.501.

Referring to FIG. 1, FIG. 1 shows the architecture for the 5G system for supporting IEEE time-sensitive networking (TSN). A user equipment (UE) and a device-side TSN translator (DS-TT) serve as a bridge between a TSN system and the 5G system, and may communicate with a 5G core network through a radio access network (PAN).

The core network may consist of main elements, such as an access and mobility management function (AM4F), a session management function (SMF), and a policy control function (PCF), and these are responsible for user session management and policy application. In addition, a unified data management (UDM) and a network exposure function (NEF) may perform additional support.

A user plane function (UPF) and a network-side TSN translator (NW-TT) may handle user traffic, and may hand time-sensitive traffic in synchronisation with a time-sensitive networking application function (TSN AF). The TSN AF may manage interaction between the 5G system and an external TSN system, guaranteeing that time-sensitive traffic will be delivered at the accurate time. Through this, the 5G system operates as a logical TSN bridge, and may support services (e.g., industrial automation, and autonomous driving) that require low-latency, high-reliability communication, through interworking with the external TSN system.

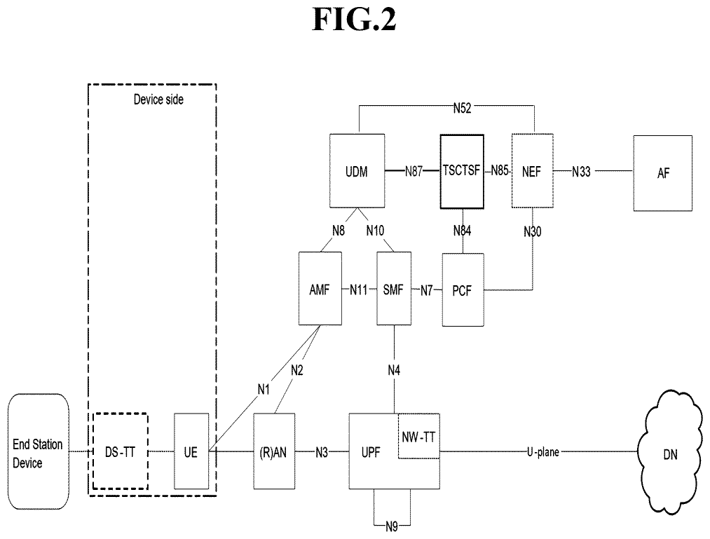

FIG. 2 shows another example of the architecture of a 5G system that supports a time-sensitive service according to various embodiments of the present disclosure. Specifically, FIG. 2 shows an example of the 5G system for supporting time-sensitive communication. FIG. 2 may be based on 3GPP TS 23.501.

Referring to FIG. 2, FIG. 2 shows the architecture for the 5G system for supporting time-sensitive communication. A user equipment (UE) and a device-side TSN translator (DS-TT) may connect a TSN system to a 5G network, and may communicate with a 5G core network through a radio access network (RAN). The core network (CN) may consist of an access and mobility management function (AMF), a session management function (SMF), and a policy control function (PCF), and each of the elements may be responsible for functions for user session management, network policy application, and time-sensitive communication support.

For TSN and time-sensitive communication, the core network may further include a time-sensitive communication and time synchronization function (TSCTSF) and a network exposure function (NEF). A user plane function (UPF) and a network-side TSN translator (NW-TT) may handle user traffic, and may support high-precision timing and low-latency communication in association with TSN. Through connection to an external data network (DN), a time-sensitive application service may be stably provided.

The architecture shown in FIG. 2 focuses on providing a 5G network environment that meets the requirements of time-sensitive applications, such as industrial automation and smart factories.

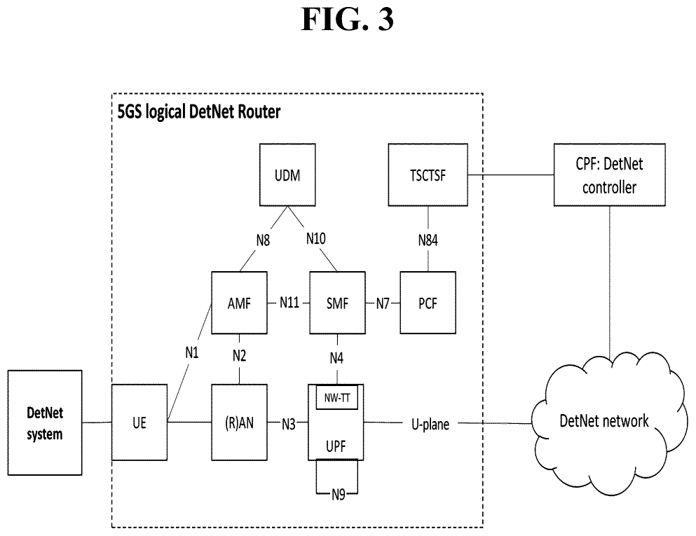

FIG. 3 shows still another example of the architecture of a 5G system that supports a time-sensitive service according to various embodiments of the present disclosure. Specifically, FIG. 3 shows an example of a 5G system for supporting IEFT deterministic networking. FIG. 3 may be based on 3GPP TS 23.501.

Referring to FIG. 3, FIG. 3 shows the architecture for the 5G system for supporting IETF deterministic networking (DetNet). A user equipment (UE) may be connected to a 5G core network through a radio access network (RAN). The core network may consist of an access and mobility management function (AMF), a session management function (SMF), a policy control function (PCF), a unified data management (UDM), and a time-sensitive communication and time synchronization function (TSCTSF). A user plane function (UPF) may connect a 5G network and a deterministic network (DetNet) via a network-side TSN translator (NW-TT). A centralized path computation function (CPF) computes and manages a path of the DetNet network, and enables the 5G system to operate as a logical DetNet router and interact with the deterministic network. The architecture shown in FIG. 3 may provide a network environment suitable for services that require high-precision timing and low-latency, high-reliability communication.

According to the 3GPP standards (e.g., TS23.501 and TS23.502), it is defined that in order for a 5G system to support a time-sensitive service, the TSN AF or TSCTSF and the UPF/NW-TT or UE/DS-TT may transmit and receive information required for time-sensitive traffic control therebetween in the form of user plane node management information (UMI) or port management information (PMI) to and from each other.

Table 1 and Table 2 may show user plane node management information (UMI) and port management information (PMI) provided by the TSN AF or TSCTSF to the UPF/NW-TT or UE/DS-TT. Table 1 and Table 2 may be based on TS 23.501.

TABLE 1
User plane node management information

Information for 5GS bridge/router
Traffic forwarding information
General neighbor discovery configuration
DS-TT port neighbor discovery configuration for DS-TT ports
Discovered neighbor information for DS-TT ports
Stream parameters
Time synchronization information
Time synchronization information for PTP instances
IEEE Std 1588 data sets
IEEE Std 802.1AS data sets
Time synchronization information for DS-TT ports
Time synchronization status (TSS) information

Referring to Table 1, information for a 5GS bridge/router may be a logical entity that serves as an interface between the 5G system and the time-sensitive networking (TSN) network. Information for a 5GS bridge/router may consist of a device-side TSN translator (DS-TT) and a network-side TSN translator (NW-TT).

Traffic forwarding information may include the details defined in section 8.8.1 of IEEE Std 802.1Q, and may include information, such as a destination MAC address, a VLAN ID, and a port number, on a TSN stream.

General neighbor discovery configuration and DS-TT port neighbor discovery configuration may be configuration information for neighbor discovery in the DS-TT and the NW-TT. When the DS-TT does not support neighbor discovery, the TSN AF may provide the NW-TT with general neighbor discovery configuration and DS-TT port neighbor discovery configuration to perform neighbor discovery instead of the DS-TT.

Discovered neighbor information for DS-TT ports is neighbor information discovered for DS-TT ports, and may include information collected through the Link Layer Discovery Protocol (LLDP).

Stream parameters may be parameters to support per-stream filtering and policing (PSFP) information defined in section 12.31.1 of IEEE Std 802.1Q.

Time synchronization information may be important for accurate time synchronisation between the 5GS and the TSN network. Time synchronization information may include synchronization information for precision time protocol (PTP) instances, IEEE Std 1588 and IEEE Std 802.1AS data sets, time synchronization information for DS-TT ports, and time synchronization status (TSS) information.

Time synchronization information for PTP instances may be synchronization information for precision time protocol (PTP) instances.

IEEE Std 1588 data sets and IEEE Std 802.1AS data sets are data sets defined in the IEEE 1588 and IEEE 802.1AS standards, and may include information for precise time synchronisation.

Time synchronization information for DS-TT ports may be time synchronization information specific to DS-TT ports.

Time synchronization status (TSS) information is information on a time synchronization status, and may indicate the current synchronisation status and quality.

TABLE 2
Port management information

Traffic class information
Gate control information
General neighbor discovery configuration
NW-TT port neighbor discovery configuration
DS-TT port neighbor discovery configuration
Neighbor discovery information for each discovered neighbor
of NW-TT
Neighbor discovery information for each discovered neighbor
of DS-TT
Information for deterministic networking for each NW-TT port
Stream parameters
Per-stream filtering and policing information
Stream filter instance table
Stream gate instance table
Time synchronization information
PTP instance specification
IEEE Std 1588 data sets
IEEE Std 802.1AS data sets

Referring to Table 2, traffic class information may define QoS parameters for various traffic classes.

Gate control information may control traffic scheduling through time-aware gates.

General neighbor discovery configuration may mean the general settings for neighbor discovery throughout the 5G system. Basic neighbor discovery parameters required for interworking with the TSN network may be defined.

NW-TT port neighbor discovery configuration may be a neighbor discovery configuration specific to the NW-TT.

DS-TT port neighbor discovery configuration may be a neighbor discovery configuration specific to the DS-TT.

Neighbor discovery information for each discovered neighbor of the NW-TT may be reported to the TSN AF so that 5GS bridge information is configured.

Neighbor discovery information for each discovered neighbor of the DS-TT may be reported to the TSN AF so that 5GS bridge information is configured.

Information for deterministic networking for each NW-TT port may include traffic classes, gate control information, and QoS parameters, and may be information required for the 5G system to operate integrated with the TSN network.

Stream parameters are parameters for supporting per-stream filtering and policing (PSFP) information, and may include MaxStreamFilterInstances, and MaxStreamGateInstances.

Per-stream filtering and policing information may define filtering and policing rules for a particular stream.

A stream filter instance table and a stream gate instance table may define filtering rules for each stream and a gate operation for controlling traffic scheduling

Time synchronization information may be information accurate time synchronization between the 5G system and the TSN network.

PTP instance specification may define PTP instances in which the 5G system operates. Modes, such as a time recognition system, a boundary clock, and a transparent clock, may be operated.

IEEE Std 1588 data sets and IEEE Std 802.1AS data sets may be data sets for precise time synchronisation and a time recognition system.

TABLE 3

| Attribute | Description |
|---|---|
| User plane node management | 5GS TSN bridge or router |
| information container | information exchanged |
| | transparently between NW-TT |
| | and TSN AF or TSCTSF via 5GS |
| | (as in Table 5.28.3.1-2). |
| Port management information | Information exchanged |
| container | transparently between NW-TT |
| | and TSN AF or TSCTSF via 5GS |
| | (as in Table 5.28.3.1-1). |
| NW-TT port number | NW-TT port number related to |
| | the PMIC. |
| Notification target address | Identifies the recipient of |
| for PMIC/UMIC UPF | the information being notified |
| event (+notification correlation | by the UPF (TSNAF/TSCTSF). |
| ID) for PMIC/UMIC UPF event | |

Referring to Table 3, Table 3 shows the details of information exchange for integration between the 5G system and the time-sensitive networking (TSN) network.

Regarding a user plane node management information container, 5GS TSN bridge or router information may be exchanged transparently between a network-side TSN translator (NW-TT) and a time-sensitive networking application function (TSN AF) or a time-sensitive communication traffic steering function (TSCTSF) through the 5GS.

A port management information container may be information that is transparently exchanged between the NW-TT and the TSN AF or TSCTSF through the 5GS. This may include information related to port management.

A NW-TT port number may indicate the NW-TT port number related to the port management information container (PMIC).

A notification target address for a PMIC/UMIC UPF event (+ notification correlation ID for PMIC/UMIC UPF event) may identify the target to receive information that the user plane function (UPF) reports about the PMIC/UMIC event. Herein, a notification correlation ID may be included.

Table 3 describes various information containers for managing interaction with the TSN network in the 5G system, and roles of the containers. This may enable smooth communication between the network elements and management.

In Table 1, the SMF may receive the UMI and the PMI from the TSN AF or TSCTSF via the PCF through a service based interface (SBI) interface. The SMF may include the received UMI and PMI in the TSC management information shown in Table 3 and may retransmit the UMI and PMI to the UPF/NW-TT through an N4 message.

In addition, the SMF may put the received PMI to an NAS message to retransmit the PMI to the UE/DS-TT. The UPF/NW-TT may execute the requirements of the TSN AF or TSCTSF on the basis of the UMI and the PMI, and may transmit the execution results to the SMF via the N4 protocol. The SMF may transmit the UMI and PMI back to the TSN AF or TSCTSF via the PCF through the SBI interface. Alternatively, the UPF/NW-TT may transmit the UMI or PMI directly to the TSN AF or TSCTSF through the SBI interface. The UE/DS-TT may execute the requirements of the TSN AF or TSCTSF on the basis of the PMI, and may transmit an NAS message containing the execution results to the SMF. The SMF may transmit the PMI back to the TSN AF or TSCTSF via the PCF through the SBI interface.

Referring to Table 1, in order to provide time-sensitive traffic at an accurate time, the UPF/NW-TT or UE/DS-TT requires a frame preemption function, and frame preemption information for managing the frame preemption function needs to be provided from the TSN AF or TSCTSF. In 3GPP Rel-16/17/18, there is no way to provide frame preemption information between the TSN AF or TSCTSF and the UPF/NW-TT or UE/DS-TT. Accordingly, the present disclosure proposes a method of providing the frame preemption information between the TSN AF/TSCTSF and the UPF/NW-TT or UE/DS-TT.

Table 4 shows user plane node management information including frame preemption information according to an embodiment of the present disclosure.

TABLE 4
User plane node management information

Information for 5GS bridge/router
Traffic forwarding information
General neighbor discovery configuration
DS-TT port neighbor discovery configuration for DS-TT ports
Discovered neighbor information for DS-TT ports
Stream parameters
Time synchronization information
Time synchronization information for PTP instances
IEEE Std 1588 data sets
IEEE Std 802.1AS data sets
Time synchronization information for DS-TT ports
Time synchronization status (TSS) information
Frame preemption information

Table 5 shows port management information including frame preemption information according to an embodiment of the present disclosure.

TABLE 5
Port management information

Traffic class information
Gate control information
General neighbor discovery configuration
NW-TT port neighbor discovery configuration
DS-TT port neighbor discovery configuration
Neighbor discovery information for each discovered neighbor
of NW-TT
Neighbor discovery information for each discovered neighbor
of DS-TT
Information for deterministic networking for each NW-TT port
Stream parameters
Per-stream filtering and policing information
Stream filter instance table
Stream gate instance table
Time synchronization information
PTP instance specification
IEEE Std 1588 data sets
IEEE Std 802.1AS data sets
Frame preemption information

Table 4 and Table 5 show the user plane node management information and the port management information that include the user plane node management information shown in Table 1 and the port management information shown in Table A01 frame preemption information, in order for the TSN AF or TSCTSF of the 5G system to provide frame preemption information to the UPF/NW-TT or UE/DS-TT according to an embodiment of the present disclosure.

Table 6 shows frame preemption information provided by the TSN AF or TSCTSF of the 5G system to the UPF/NW-TT or UE/DS-TT according to an embodiment of the present disclosure.

TABLE 6

| Attribute | Description | Reference |
|---|---|---|
| framePreemptionStatusTable | Consists of | IEEE 802.1Q-2022 |
| | framePreemptionAdminStatus | |
| | values for eight priorities. | |
| | framePreemptionAdminStatus | |
| | indicates the preemption | |
| | status | |
| holdAdvance | The maximum time during which | IEEE 802.1Q-2022 |
| | preemptable frames are held | |
| releaseAdvance | The maximum time during which | IEEE 802.1Q-2022 |
| | preemptable frames are | |
| | released | |
| preemptionActive | Indicating whether a | IEEE 802.1Q-2022 |
| | preemption function for a | |
| | particular port is active | |
| holdRequest | Request to hold preemptable | IEEE 802.1Q-2022 |
| | frames | |
| LldpXdot3LocPreemptSupported | Whether a frame preemption | IEEE 802.3br-2016 |
| | function of a local port for | |
| | LLDP is supported | |
| LldpXdot3LocPreemptEnabled | Whether a frame preemption | IEEE 802.3br-2016 |
| | function of a local port for | |
| | LLDP is enabled | |
| LldpXdot3LocPreemptActive | Whether a frame preemption | IEEE 802.3br-2016 |
| | function of a local port for | |
| | LLDP is active | |
| LldpXdot3LocAddFragSize | The fragment size of a local | IEEE 802.3br-2016 |
| | port for LLDP | |
| LldpXdot3RemPreemptSupported | Whether a frame preemption | IEEE 802.3br-2016 |
| | function of a remote port for | |
| | LLDP is supported | |
| LldpXdot3RemPreemptEnabled | Whether a frame preemption | IEEE 802.3br-2016 |
| | function of a remote port for | |
| | LLDP is enabled | |
| LldpXdot3RemPreemptActive | Whether a frame preemption | IEEE 802.3br-2016 |
| | function of a remote port for | |
| | LLDP is active | |
| LldpXdot3RemAddFragSize | The fragment size of a local | IEEE 802.3br-2016 |
| | port for LLDP | |
| MACMergeSupport | Whether a MAC merge sublayer | IEEE 802.3br-2016 |
| | is supported | |
| MACMergeStatusVerify | Whether a MAC merge sublayer | IEEE 802.3br-2016 |
| | is in a verification status | |
| MACMergeEnableTx | Whether a MAC merge sublayer | IEEE 802.3br-2016 |
| | in the Tx direction is in an | |
| | enable state | |
| MACMergeVerifyDisableTx | Whether the verification | IEEE 802.3br-2016 |
| | status of a MAC merge sublayer | |
| | in the Tx direction is in a | |
| | disable status | |
| MACMergeStatusTx | Whether a MAC merge sublayer | IEEE 802.3br-2016 |
| | in the Tx direction is in an | |
| | active status | |
| MACMergeVerifyTime | The time taken for | IEEE 802.3br-2016 |
| | verification of the MAC merge | |
| | sublayer | |
| MACMergeAddFragSize | The fragment size of the | IEEE 802.3br-2016 |
| | MAC merge sublayer | |
| MACMergeFrameAssErrorCount | The number of MAC frames with | IEEE 802.3br-2016 |
| | reassembly errors | |
| MACMergeFrameSmdErrorCount | The number of MAC frames with | IEEE 802.3br-2016 |
| | SMD errors | |
| MACMergeFrameAssOkCount | The number of MAC frames | IEEE 802.3br-2016 |
| | successfully reassembled | |
| MACMergeFragCountRx | The number of Rx packets | IEEE 802.3br-2016 |
| | subjected to preemption | |
| MACMergeFragCountTx | The number of Tx packets | IEEE 802.3br-2016 |
| | subjected to preemption | |
| MACMergeHoldCount | The number of times that | IEEE 802.3br-2016 |
| | Hold is performed | |

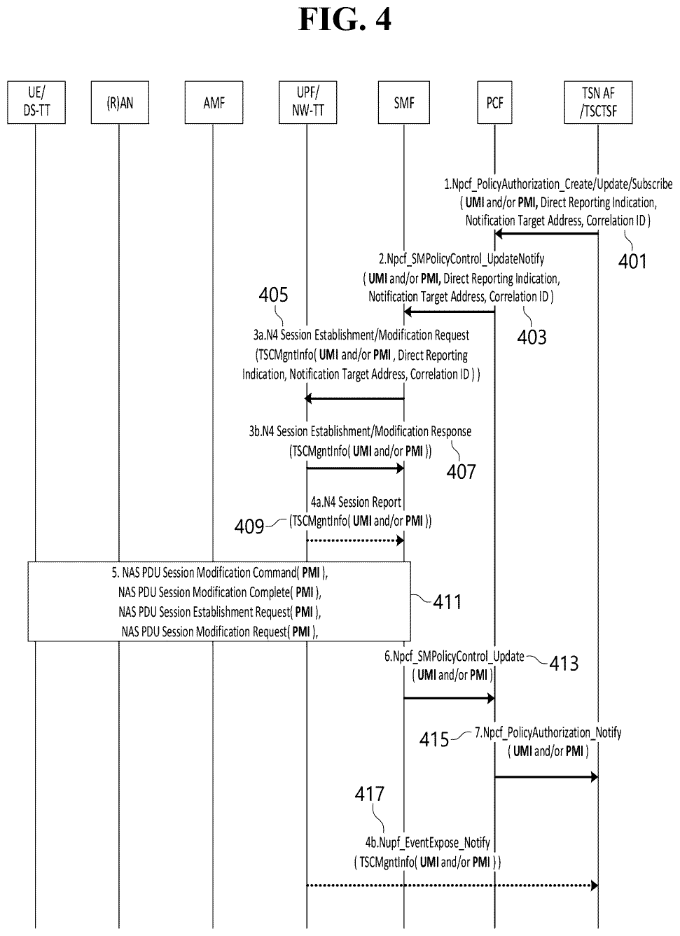

FIG. 4 shows an example for a TSN AF or TSCTSF to provide UMI or PMI according to various embodiments of the present disclosure.

Referring to FIG. 4, the TSN AF or TSCTSF may transmit the Npcf_PolicyAuthorization_Create/Update/Subscribe message to the PCF in step 401. According to an embodiment, the Npcf_PolicyAuthorization_Create/Update/Subscribe message may include at least one selected from the group of UMI, PMI, a direct reporting indication, a notification target address, and a correlation ID.

The PCF may transmit the Npcf_SMPolicyControl_UpdateNotify message to the SMF in step 403. According to an embodiment, the Npcf_SMPolicyControl_UpdateNotify message may include at least one selected from the group of UMI, PMI, a direct reporting indication, a notification target address, and a correlation ID.

Specifically, in steps 401 and 403, the SMF may receive the UMI and the PMI from the TSN AF or TSCTSF via the PCF through the SBI interface.

The SMF may transmit an N4 session establishment/modification request to the UPF or the NW-TT in step 405. According to an embodiment, the N4 session establishment/modification request includes TSC management information (TSCMgntInfo). The TSC management information (TSCMgntInfo) may include at least one selected from the group of the UMI, PMI, direct reporting indication, notification target address, and correlation ID. That is, in step 405, the SMF may retransmit the TSC management information including the received UMI and PMI to the UPF or NW-TT through an N4 message.

The UPF or NW-TT may transmit an N4 session establishment/modification response message to the SMF in step 407. According to an embodiment, the N4 session establishment/modification response message may include the TSC management information (TSCMgntInfo). The TSC management information may include the UMI or the PMI or both. That is, the UPF or NW-TT may execute the requirements of the TSN AF or TSCTSF on the basis of the UMI and the PMI, and may transmit execution results to the SMF via the N4 protocol.

The UPF or NW-TT may transmit an N4 session report message to the SMF in step 409. According to an embodiment, the N4 session report message may include the TSC management information (TSCMgntInfo). The TSC management information may include the UMI or the PMI or both. That is, when the details of UMI or PMI are changed, the UPF or NW-TT may be reported to the SMF later through an N4 session report message.

The SMF may retransmit an NAS message including the PMI to the UE or DS-TT in step 411. According to an embodiment, the NAS message may be at least one selected from the group of the NAS PDU session modification command, NAS PDU session modification complete, NAS PDU session establishment request, and NAS PDU session modification request.

The SMF may transmit the Npcf_SMPolicyControl_Update message to the PCF in step 413. According to an embodiment, the Npcf_SMPolicyControl_Update message may include the UMI or the PMI or both.

The PCF may transmit the Npcf_PolicyAuthorization_Notify message to the TSN AF or TSCTSF in step 415. According to an embodiment, the Npcf_PolicyAuthorization_Notify message may include the UMI or the PMI or both.

In steps 413 and 415, the SMF may transmit the UMI or the PMI or both back to the TSF AF or TSCTSF via the PCF through the SBI interface.

In steps 411 to 415, the UE or DS-TT may execute the requirements of the TSN AF or TSCTSF on the basis of the PMI, and may transmit an NAS message containing the execution results to the SMF. The SMF may transmit the PMI back to the TSN AF or TSCTSF via the PCF through the SBI interface.

The UPF or NW-TT may transmit the Nupf_EventExpose_Notify message to the TSN AF or TSCTSF in step 417. According to an embodiment, the Nupf_EventExpose_Notify message may include the TSC management information (TSCMgnInfo). The TSC management information (TSCMgnInfo) may include the UMI or the PMI or both. That is, the UPF or NW-TT may transmit the UMI or PMI directly to the TSN AF or TSCTSF through the SBI interface.

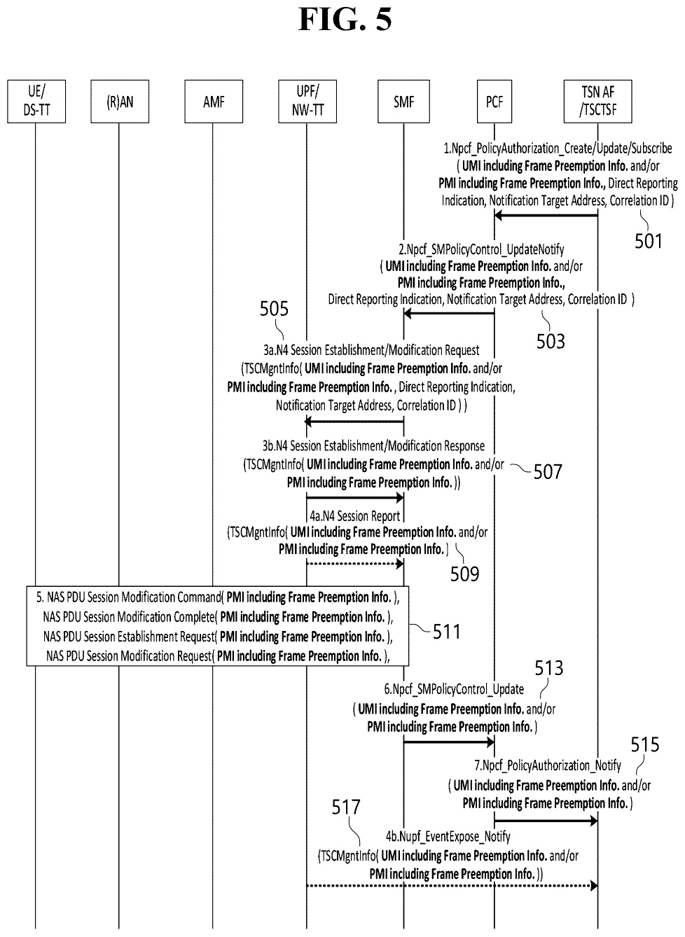

FIG. 5 shows an example for a TSN AF or TSCTSF to provide UMI or PMI according to an embodiment of the present disclosure.

Referring to FIG. 5, the Npcf service operation, N4 message, NAS message, and Nupf service operation may include the UMI and the PMI that include the frame preemption information. FIG. 5 has the same procedure as FIG. 4, but further includes frame preemption information in addition to the UMI and the PMI.

Referring to FIG. 5, the TSN AF or TSCTSF may transmit the Npcf_PolicyAuthorization_Create/Update/Subscribe message to the PCF in step 501. According to an embodiment, the Npcf_PolicyAuthorization_Create/Update/Subscribe message may include at least one selected from the group of the UMI including the frame preemption information (Frame Preemption Info), the PMI including the frame preemption information (Frame Preemption Info), directing reporting indication, notification target address, and correlation ID.

The PCF may transmit the Npcf_SMPolicyControl_UpdateNotify message to the SMF in step 503. According to an embodiment, the Npcf_SMPolicyControl_UpdateNotify message may include at least one selected from the group of the UMI including the frame preemption information (Frame Preemption Info), the PMI including the frame preemption information (Frame Preemption Info), directing reporting indication, notification target address, and correlation ID.

The SMF may transmit an N4 session establishment/modification request message to the UPF or the NW-TT in step 505. According to an embodiment, the N4 session establishment/modification request may include TSC management information (TSCMgntInfo). The TSC management information (TSCMgntInfo) may include at least one selected from the group of the PMI, directing reporting indication, notification target address, and correlation ID.

The UPF or NW-TT may transmit an N4 session establishment/modification response message to the SMF in step 507. The N4 session establishment/modification response message may include the TSC management information (TSCMgntInfo). The TSC management information (TSCMgntInfo) may include at least one selected from the group of the PMI, directing reporting indication, notification target address, and correlation ID.

The UPF or NW-TT may transmit an N4 session report message to the SMF in step 509. The N4 session report message may include the TSC management information (TSCMgntInfo). The TSC management information (TSCMgntInfo) may include at least one selected from the group of PMI, directing reporting indication, notification target address, and correlation ID.

The SMF may retransmit an NAS message including the PMI including the frame preemption information to the UE or DS-TT in step 511. According to an embodiment, the NAS message may be at least one selected from the group of the NAS PDU session modification command, NAS PDU session modification complete, NAS PDU session establishment request, and NAS PDU session modification request.

The SMF may transmit the Npcf_SMPolicyControl_Update message to the PCF in step 413. According to an embodiment, the Npcf_SMPolicyControl_Update message may include the UMI including the frame preemption information or the PMI including the frame preemption information or both.

The PCF may transmit the Npcf_PolicyAuthorization_Notify message to the TSN AF or TSCTSF in step 415. According to an embodiment, the Npcf_PolicyAuthorization_Notify message may include the UMI including the frame preemption information or the PMI including the frame preemption information or both.

The UPF or NW-TT may transmit the Nupf_EventExpose_Notify message to the TSN AF or TSCTSF in step 517. According to an embodiment, the Nupf_EventExpose_Notify message may include the TSC management information (TSCMgntInfo). The TSC management information (TSCMgntInfo) may include the UMI including the frame preemption information or the PMI including the frame preemption information or both.

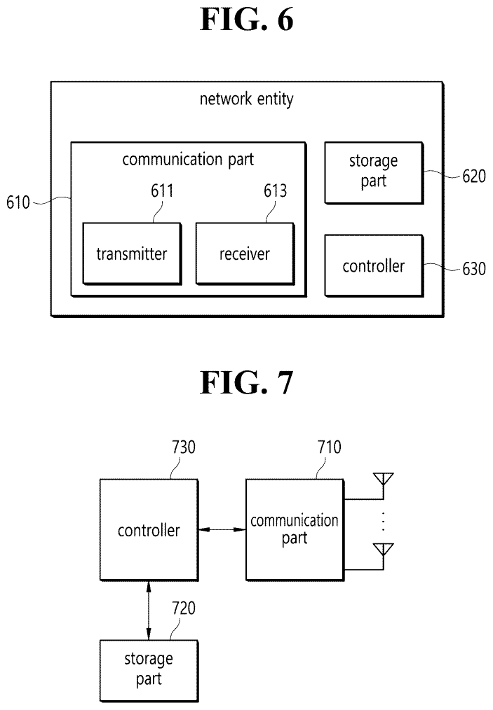

FIG. 6 shows the configuration of a network entity in a wireless communication system according to various embodiments of the present disclosure.

A network entity in the present disclosure is a concept that includes a network function according to the implementation of the system. The terms “˜part”, “˜unit”, and the like used below mean a unit for processing at least one function or operation, and may be implemented by hardware, software, or a combination of hardware and software.

According to various embodiments of the present disclosure, the network entity may include a communication part 610, a storage part 620, and a controller 630 that controls the overall operation of the network entity. The communication part 610 transmits and receives signals to and from other network entities. Accordingly, all or part of the communication part 610 may be referred to as a “transmitter” 611, a “receiver” 613, or a “transceiver” 610. The storage part 620 stores therein data, such as default programs, application programs, and setting information for the operation of the network entity. The storage part 620 may be a volatile memory, a non-volatile memory, or a combination of a volatile memory and a non-volatile memory. In addition, the storage part 620 may provide stored data according to a request of the controller 630. The controller 630 controls overall operations of the network entity. For example, the controller 630 transmits and receives signals through the communication part 610. In addition, the controller 630 may record data on the storage part 620, and may read the data. In addition, the controller 630 may perform functions of a protocol stack that communication standards require. To this end, the controller 630 may include a circuit, an application-specific circuit, and at least one processor or microprocessor, or may be part of a processor. In addition, part of the communication part 610 and the controller 630 may be referred to as a communication processor (CP). The controller 630 may control the network entity so that any one of the operations of the various embodiments of the present disclosure is performed. The communication part 610 and the controller 630 are not necessarily implemented as separate modules, and may be implemented as a single component in the form of a single chip or a software block, for example. The communication part 610, the storage part 620, and the controller 630 may be electrically connected to each other. In addition, the operations of the network entity may be realized by having the storage part 620 storing the corresponding program code therein within the network entity. The network entity may include a network node, and may be any one of the followings: a base station (RAN), AMF, SMF, UPF, NF, NEF, NRF, CF, NSSF, UDM, AF, AUSF, SCP, UDSF, PCF, TSN AF, NW-TT, DS-TT, context storage, OAM, EMS, configuration server, and identifier (ID) management server.

FIG. 7 shows a configuration diagram of a user equipment in a wireless communication system according to various embodiments of the present disclosure. The configuration illustrated in FIG. 7 may be understood as a configuration of a user equipment. The terms “˜part”, “˜unit”, and the like used below mean a unit for processing at least one function or operation, and may be implemented by hardware, software, or a combination of hardware and software.

Referring to FIG. 7, a user equipment may include a communication part 710, a storage part 720, and a controller 730.

The communication part 710 may perform functions for transmitting and receiving signals through a wireless channel. For example, the communication part 710 may perform a function of conversion between a baseband signal and a bit string according to the physical layer standards of a system. For example, when transmitting data, the communication part 710 may generate complex symbols by encoding and modulating a transmission bit string. When receiving data, the communication part 710 may restore a reception bit string by demodulating and decoding a baseband signal. In addition, the communication part 710 may up-convert a baseband signal into an RF band signal and transmit the RF band signal through an antenna, and may down-convert an RF band signal received through an antenna into a baseband signal. For example, the communication part 710 may include a transmission filter, a reception filter, an amplifier, a mixer, an oscillator, a DAC, and an ADC.

In addition, the communication part 710 may include multiple transmission and reception paths. Furthermore, the communication part 710 may include at least one antenna array composed of multiple antenna elements. In terms of hardware, the communication part 710 may be a digital circuit and an analog circuit (for example, a radio frequency integrated circuit (RFIC)). Herein, the digital circuit and the analog circuit may be realized as one package. In addition, the communication part 710 may include multiple RF chains. Furthermore, the communication part 710 may perform beamforming.

The communication part 710 transmits and receives signals as described above. Accordingly, all or part of the communication part 710 may be referred to as a “transmitter”, “receiver”, or “transceiver”. In addition, in the following description, transmission and reception performed through a wireless channel may be used to mean that the communication part 710 performs the above-described processing.

The storage part 720 may store therein data, such as default programs, application programs, and setting information for the operation of the user equipment. The storage part 720 may be a volatile memory, a non-volatile memory, or a combination of a volatile memory and a non-volatile memory. In addition, the storage part 720 may provide stored data according to a request of the controller 730.

The controller 730 may control overall operations of the user equipment. For example, the controller 730 may transmit and receive signals through the communication part 710. In addition, the controller 730 may record data on the storage part 720 and may read the data. The controller 730 may perform functions of a protocol stack that communication standards require. To this end, the controller 730 may include at least one processor or microprocessor, or may be part of a processor. In addition, part of the communication part 710 and the controller 730 may be referred to as a communication processor (CP).

According to various embodiments, the controller 730 may perform control so that the above-described user equipment performs the operations according to the various embodiments.

Methods according to the embodiments described in the claims of the present disclosure or in the specification may be implemented in the form of hardware, software, or a combination of hardware and software.

In the case of software implementation, a computer-readable storage medium in which at least one program (software module) is stored may be provided. The at least one program stored in the computer-readable storage medium is configured to be executable by at least one processor in an electronic device. The at least one program includes instructions for the electronic device to execute the methods according to the embodiments described in the claims of the present disclosure or the specification.

The program (software module or software) may be stored in non-volatile memory including random-access memory and flash memory, read-only memory (ROM), electrically erasable programmable read-only memory (EEPROM), a magnetic disc storage device, a compact disc-ROM (CD-ROM), digital versatile discs (DVDs), optical storage devices of other types, or a magnetic cassette. Alternatively, the program may be stored in a memory composed of a combination of some or all of these memories. In addition, a plurality of such memories may be included.

In addition, the program may be stored in an attachable storage device that is accessible through a communication network, such as the Internet, Intranet, a local area network (LAN), a wide area network (WAN), or a storage area network (SAN), or a combination thereof. The storage device may be connected through an external port to an apparatus performing an embodiment of the present disclosure. In addition, a separate storage device on the communication network may be connected to the apparatus performing an embodiment of the present disclosure.

In the above-described detailed embodiments of the disclosure, an element included in the disclosure is expressed in the singular or the plural according to a presented detailed embodiment. However, the singular form or plural form is selected suitable for the presented situation for convenience of description, and the various embodiments of the disclosure are not limited to a single element or multiple elements thereof. Further, either multiple elements expressed in the description may be configured into a single element or a single element in the description may be configured into multiple elements.

Although the specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. An operation method of a session management function (SMF) for providing a time-sensitive service in a wireless communication system, the operation method comprising:
receiving frame preemption information from a time-sensitive networking application function (TSN AF) or a time-sensitive communication and time synchronization function (TSCTSF) via a policy control function (PCF) through an SBI interface;
retransmitting the frame preemption information from the PCF to a user plane function (UPF)/network-side TSN translator (NW-TT) through an N4 interface;
transmitting the frame preemption information from the PCF to a user equipment (UE)/device-side TSN translator (DS-TT) through an Ni NAS interface; and
receiving the frame preemption information set from the UPF/NW-TT through the N4 interface and from the UE/DS-TT through the Ni NAS interface, and transmitting the frame preemption information to the TSN AF or the TSCTSF via the PCF through the SBI interface.

2. The operation method of claim 1, wherein a service operation of receiving, by the PCF, the frame preemption information from the TSN AF or the TSCTSF through the SBI interface is at least one selected from a group of Npcf_PolicyAuthorization_Create, Npcf_PolicyAuthorization_Update, and Npcf_PolicyAuthorization_Subscribe operations, and
a service operation of transmitting, by the PCF, the frame preemption information to the TSN AF or the TSCTSF is an Npcf_PolicyAuthorization_Notify operation.

3. The operation method of claim 1, wherein a service operation of transmitting, by the PCF, the frame preemption information to the SMF through the SBI interface is an Npcf_SMPolicyControl_UpdateNotify operation, and
a service operation of receiving, by the PCF, the frame preemption information from the SMF is an Npcf_SMPolicyControl_Update operation.

4. The operation method of claim 1, wherein a protocol by which the frame preemption information is transmitted and received between the SMF and the UPF/NW-TT includes at least one selected from a group of an N4 packet forward control protocol (PFCP), N4 session establishment, N4 session modification, and N4 session report messages.

5. The operation method of claim 1, wherein a message by which the SMF transmits the frame preemption information to the UE/DS-TT through the Ni NAS interface is an NAS PDU session modification command message.

6. The operation method of claim 1, wherein a message by which the UE/DS-TT transmits the frame preemption information to the SMF through the Ni NAS interface is at least one selected from a group of NAS PDU session establishment request, NAS PDU session modification request, and NAS PDU session modification complete messages.

7. The operation method of claim 1, wherein an operation of transmitting, by the UPF/NW-TT, the frame preemption information directly to the TSN AF or the TSCTSF through the SBI interface is an Nupf_EvenExposure_Notify service operation.

8. The operation method of claim 1, wherein the frame preemption information transferred by the TSN AF or the TSCTSF, and by the UPF/NWTT or the UE/DS-TT includes at least one selected from a group of framePreemptionStatusTable, holdAdvance, releaseAdvance, preemptionActive, holdRequest, LldpXdot3LocPreemptSupported, LldpXdot3LocPreemptEnabled, LldpXdot3LocPreemptActive, LldpXdot3LocAddFragSize, LldpXdot3RemPreemptSupported, LldpXdot3RemPreemptEnabled, LldpXdot3RemPreemptActive, LldpXdot3RemAddFragSize, MACMergeSupport, MACMergeStatusVerify, MACMergeEnableTx, MACMergeVerifyDisableTx, MACMergeStatusTx, MACMergeVerifyTime, MACMergeAddFragSize, MACMergeFrameAssErrorCount, MACMergeFrameSmdErrorCount, MACMergeFrameAssOkCount, MACMergeFragCountRx, MACMergeFragCountTx, and MACMergeHoldCount.

9. A session management function (SMF) for providing a time-sensitive service in a wireless communication system, the session management function comprising:
a transceiver; and
a controller operably connected to the transceiver, wherein the controller is configured to
receive frame preemption information from a time-sensitive networking application function (TSN AF) or a time-sensitive communication and time synchronization function (TSCTSF) via a policy control function (PCF) through an SBI interface,
retransmit the frame preemption information from the PCF to a user plane function (UPF)/network-side TSN translator (NW-TT) through an N4 interface,
transmit the frame preemption information from the PCF to a user equipment (UE)/device-side TSN translator (DS-TT) through an Ni NAS interface, and
receive the frame preemption information set from the UPF/NW-TT through the N4 interface and from the UE/DS-TT through the Ni NAS interface, and transmit the frame preemption information to the TSN AF or the TSCTSF via the PCF through the SBI interface.

10. The session management function of claim 9, wherein a service operation of receiving, by the PCF, the frame preemption information from the TSN AF or the TSCTSF through the SBI interface is at least one selected from a group of Npcf_PolicyAuthorization_Create, Npcf_PolicyAuthorization_Update, and Npcf_PolicyAuthorization_Subscribe operations, and
a service operation of transmitting, by the PCF, the frame preemption information to the TSN AF or the TSCTSF is an Npcf_PolicyAuthorization_Notify operation.

11. The session management function of claim 9, wherein a service operation of transmitting, by the PCF, the frame preemption information to the SMF through the SBI interface is an Npcf_SMPolicyControl_UpdateNotify operation, and
a service operation of receiving, by the PCF, the frame preemption information from the SMF is an Npcf_SMPolicyControl_Update operation.

12. The session management function of claim 9, wherein a protocol by which the frame preemption information is transmitted and received between the SMF and the UPF/NW-TT includes at least one selected from a group of an N4 packet forward control protocol (PFCP), N4 session establishment, N4 session modification, and N4 session report messages.

13. The session management function of claim 9, wherein a message by which the SMF transmits the frame preemption information to the UE/DS-TT through the Ni NAS interface is an NAS PDU session modification command message.

14. The session management function of claim 9, wherein a message by which the UE/DS-TT transmits the frame preemption information to the SMF through the Ni NAS interface is at least one selected from a group of NAS PDU session establishment request, NAS PDU session modification request, and NAS PDU session modification complete messages.

15. The session management function of claim 9, wherein an operation of transmitting, by the UPF/NW-TT, the frame preemption information directly to the TSN AF or the TSCTSF through the SBI interface is an Nupf_EvenExposure_Notify service operation.

16. The session management function of claim 9, wherein the frame preemption information transferred by the TSN AF or the TSCTSF, and by the UPF/NWTT or the UE/DS-TT includes at least one selected from a group of framePreemptionStatusTable, holdAdvance, releaseAdvance, preemptionActive, holdRequest, LldpXdot3LocPreemptSupported, LldpXdot3LocPreemptEnabled, LldpXdot3LocPreemptActive, LldpXdot3LocAddFragSize, LldpXdot3RemPreemptSupported, LldpXdot3RemPreemptEnabled, LldpXdot3RemPreemptActive, LldpXdot3RemAddFragSize, MACMergeSupport, MACMergeStatusVerify, MACMergeEnableTx, MACMergeVerifyDisableTx, MACMergeStatusTx, MACMergeVerifyTime, MACMergeAddFragSize, MACMergeFrameAssErrorCount, MACMergeFrameSmdErrorCount, MACMergeFrameAssOkCount, MACMergeFragCountRx, MACMergeFragCountTx, and MACMergeHoldCount.
